(19) United States
(12) Patent Application Publication
(10) Pub. No.: US 2015/0286361 A1
(43) Pub. Date: Oct. 8, 2015

(54) SINGLE GESTURE VIDEO CAPTURE AND SHARE

(71) Applicant: Monkey Inferno, Inc., San Francisco, CA (US)

(72) Inventor: Shaan Puri, San Francisco, CA (US)

(21) Appl. No.: 14/446,147

(22) Filed: Jul. 29, 2014

Related U.S. Application Data
(60) Provisional application No. 61/975,521, filed on Apr. 4, 2014.

(51) Int. Cl. G06F 3/0488; G06F 3/0484; H04L 29/08; G06F 3/0481

(52) U.S. Cl. CPC G06F 3/0488; G06F 3/0481; G06F 3/04842; H04L 67/10

(57) ABSTRACT

A system and process that enables a user, using a single gesture, to share video content taken on a mobile device with a second mobile device. A video sharing application presents a list of contacts to the user. Upon selecting and holding one of the contacts, a video recording is started. When the contact is released, or a preset time has expired, the recording is stopped and automatically sent to the mobile device associated with the contact.

### CROSS-REFERENCE

This application claims priority from U.S. Provisional Patent Application No. 61/975,521, filed Apr. 4, 2014, entitled Single Motion Video Capture and Share, which is incorporated herein by reference in its entirety.

### TECHNICAL FIELD

This disclosure relates in general to a mobile electronic device having a camera feature, and more particularly, to methods and systems for sharing video from the camera feature using a single user gesture.

### BACKGROUND

A smartphone is a mobile digital processor-based electronic device having advanced computing and connectivity capabilities in addition to basic cellular telephone service. Such devices are well-known and commonly available. For example, in the United States, most current smartphones use either Google's Android operating system or Apple's iOS operating system.

A typical smartphone implementation includes an operating system that supports a number of standard built-in features, such as a touch screen interface, a media player, Wi-Fi connectivity, a digital camera having photo and video modes, etc. Third party applications can also be readily installed.

A popular standard feature in most modern smartphones is a digital camera application that allows the user the take and save either digital photographs or video. Camera applications typically provide an option to share the saved photo(s) or video(s) via email, message, or social media, for example. However, there are usually at least several steps involved in taking a digital photo or video, and also several steps involved in identifying and sharing the content. For example, in order to take a digital video and share the content, the user must select/open the camera application; select the video feature; record; select the recording; select an action to take with the recording, then take the action.

Thus, it would be desirable to simplify the process for capturing and sharing video content, and the present disclosure describes methods and systems for doing so with a single user gesture.

### BRIEF DESCRIPTION OF THE DRAWINGS

FIG. 1 is a block diagram illustrating a smartphone apparatus;

FIG. 2 is a block diagram illustrating a smartphone apparatus with a video sharing application installed;

FIG. 3 is a block diagram illustrating a circuit schematic for the smartphone of FIG. 2;

FIG. 4 is a flow chart of a process for downloading and installing the video sharing application on the smartphone shown in FIG. 2, and initializing contacts for the video sharing application; and

FIG. 5 is a flow chart of a process for sharing video content using the smartphone of FIG. 2.

### DETAILED DESCRIPTION

This disclosure describes a video sharing application that allows a user to select a recipient, record and transmit a video to the recipient using a single gesture.

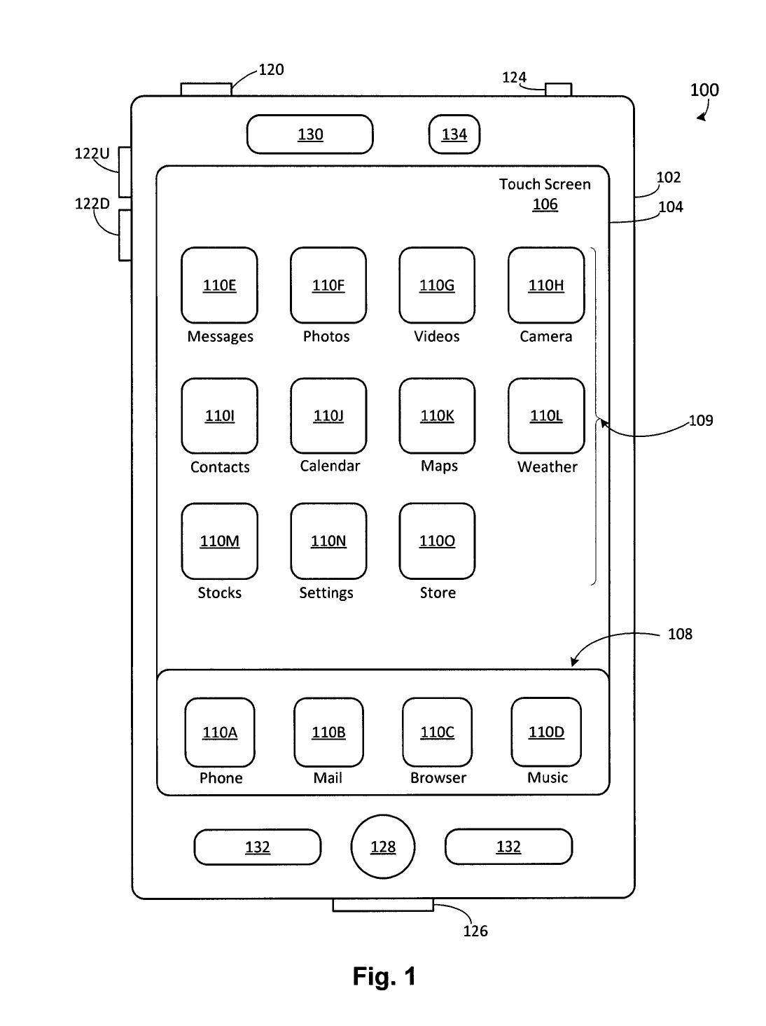

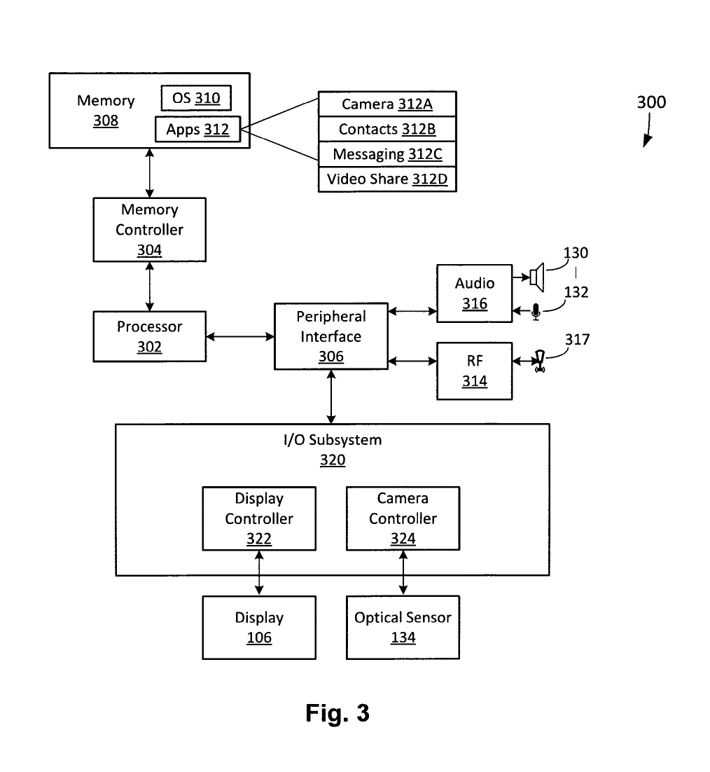

Mobile electronic devices, such as smartphones and tablets, are generally known as best exemplified by devices that run on Apple's iOS operating system or Google's Android operating system. One embodiment of a mobile electronic device 100, e.g., a smartphone, is illustrated in FIG. 1. The device 100 has a hard case 102 that contains appropriate electronic circuitry, as further described below with reference to FIG. 3. A user interface 104 is provided on the front face of the device 100, and in this embodiment the user interface includes a touch sensitive display 106, or touch screen, that is used to facilitate user input/output/selection operations with haptic contact. For example, the touch screen 106 may display one or more graphics, and the user may select or operate upon a graphic by making contact with it, i.e., touching the graphic with a finger. In some embodiments, the contact may include a gesture, such as single tap or multiple taps of the graphic with a finger, or dragging the graphic, or swiping across the graphic (left to right, right to left, upward or downward), or holding the graphic down, or pinching or stretching the graphic.

Specific gestures may be defined and a corresponding action associated with each gesture. For example, a display controller may be programmed to detect various states, such as (i) whether contact with the touch screen has occurred; (ii) whether contact with the touch screen is maintained; (iii) whether there is movement of the contact with the touch screen, and if so, tracking the movement across the touch screen; and (iv) whether contact with the touch screen has been broken (i.e., the contact has been released). By incorporating an accelerometer to provide data to the display controller, a contact maintained in a single spot on the touch screen can distinguished from a swipe which begins at the same location since the swipe has a magnitude and a direction. In the absence of such data, the contact is maintained in the same location.

The use of a touch sensitive display and/or gestures with a touch sensitive display is described in the following exemplary patents: U.S. Pat. No. 7,479,949 entitled Touch Screen Device, Method, and Graphical User Interface for Determining Commands by Applying Heuristics; U.S. Pat. No. 7,614,008 entitled Operation of a Computer with a Touch Screen Interface; U.S. Pat. No. 7,663,607 entitled Multipoint Touchscreen; U.S. Pat. No. 7,844,914 entitled Activating Virtual Keys of a Touch-Screen Virtual Keyboard; U.S. Pat. No. 8,269,784 entitled Mode-Based Graphical User Interfaces for Touch Sensitive Input Devices; U.S. Pat. No. 8,279,180 entitled Multipoint Touch Surface Controlle ; and U.S. Pat. No. 8,479,122 entitled Gestures for Touch Sensitive Input Devices.

The graphics for the interface 104 are generated to include multiple icons 110 that represent applications, features, or utilities that are installed on the device 100. For example, area 108 is a group of four icons 110A, 110B, 110C and 110D that represent a phone application, a mail application, a browser application, and a music application, respectively. The icons 110A, 110B, 110C and 110D are typically fixed in place on the primary screen so that these basic functions can be selected from any screen.

Other icons can be distributed over multiple pages, if necessary, and the user can use a gesture to swipe from one page to another. For example, area 109 is a single page that includes eleven icons: icon 110E represents a messaging application; icon 110F represents an application for viewing photos; icon 110G represents an application for viewing videos; icon 110H represents a digital camera application; icon 110I a contacts application; icon 110J represents a calendar application; icon 110K represents a mapping application; icon 110L represents a weather application; icon 110M represents an application for tracking stock prices; icon 110N represents a utility for viewing and/or changing settings for the smartphone and its applications; and icon 110O represents an application for obtaining applications, such as the App Store. Other pages may contain additional icons. Further, other graphics may be provided or generated depending on the operating state of the device 100 and user selections and/or settings, such as such as a security log-in screen, a keyboard interface, status indicators, etc.

The device 100 includes a power button 120 for powering the device on and off; a pair of volume buttons 122U, 122D for adjusting the speaker/headset volume up/down; a headset jack 124 for receiving a headset cable; an external port 126 for docking or charging the device; and a home or menu button 128. Touching the home button 128 returns the user interface 104 to a defined operating condition, e.g. displaying the primary or start interface, such as first page 109.

The device 100 also includes a speaker 130, a microphone 132, and an optical sensor 134. The optical sensor 134 receives light from the external environment, projected through one or more lenses, and in conjunction with an imaging or camera module, converts the light to digital data representing an image. The optical sensor 134 may be implemented as a charge coupled device (CCD), or as complementary metal-oxide-semiconductor (CMOS) phototransistors, for example. In some embodiments, the optical sensor 134 is located on the back face of the device 100, and the touch screen 106 is used as a view finder for displaying either still or video images captured by the sensor. The device 100 may include other functional modules as desired or necessary for certain functions, such as a proximity sensor and an accelerometer.

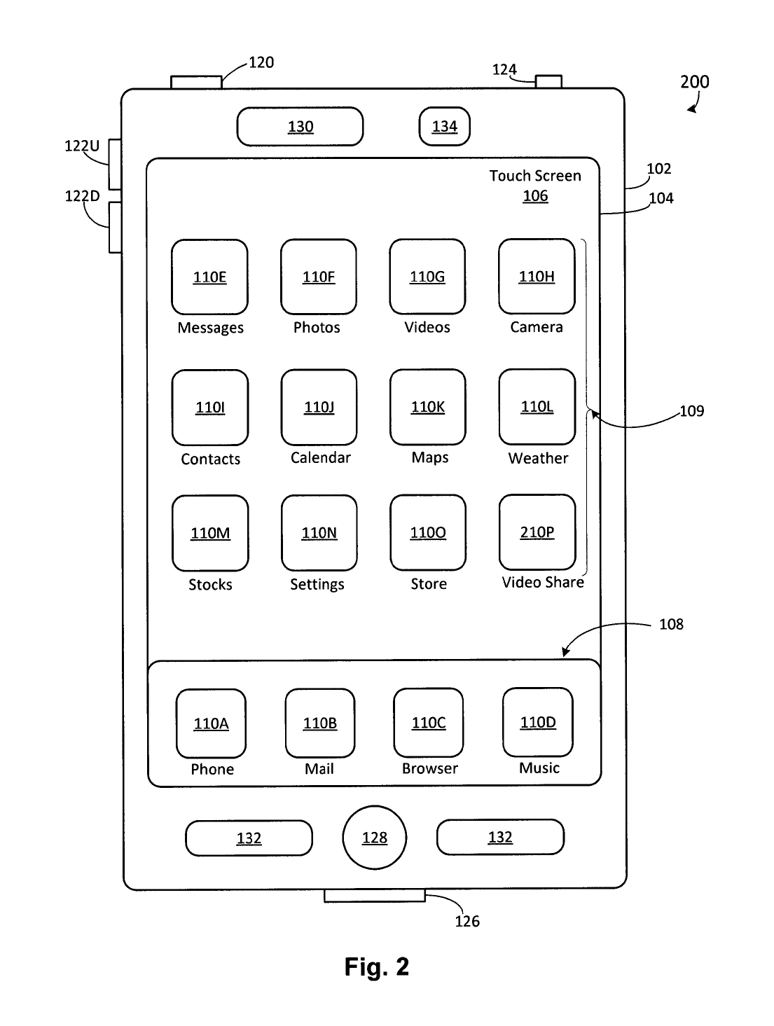

FIG. 2 illustrates another embodiment of a mobile electronic device 200. Device 200 is similar to device 100, but now includes another icon 210P in area 109 of the touch screen 104 entitled “video sharing.” The video sharing application is installed on the device 200 in the usual manner, e.g., by downloading from a known source for the application.

FIG. 3 is a block diagram illustrating one embodiment of a circuit 300 for the device 200. It should be appreciated that device 200 and corresponding circuit 300 represent only one example of a portable electronic device, and that the device may have more or fewer components or may have a different configuration than shown here. Further, the various components may be implemented in hardware, software, or a combination of both hardware and software, including one or more signal processing circuits and/or application specific integrated circuits.

The circuit 300 includes at least one processor 302 coupled to a memory controller 304 and to a peripherals interface 306. The processor 302 runs or executes software programs and/or sets of instructions stored in memory 308 to perform various functions and to process data. The memory controller 304 provides controlled access to memory 308. Memory 308 can include high-speed random access memory and may also include non-volatile memory, such as magnetic disk storage, flash memory, or other non-volatile solid state memory, or one or more computer readable storage mediums.

Memory 308 stores key software components such as an operating system 310 and multiple applications 312, but also many other components (not shown) such as a communications module, a graphics module, a text input module, and a global positioning system (GPS) module, among others. Each of these modules is generally well-known and need not be explained in detail herein. For example, the operating system includes various software components and drivers for controlling and managing general system tasks, such as memory management, storage device control, power management, etc., and facilitates communication between the various hardware and software components. For the purpose of this disclosure, the relevant applications stored in memory 308 include a camera module 312A, a contacts module 312B, a contacts module 312B, a messaging module 312C, and a video sharing module 312D.

The peripheral interface 306 couples the input and output peripherals of the device 200 to the CPU 302 and memory 308. For example, circuitry 314 is provided for sending and receiving radio frequency (RF) signals via antenna 315, and circuitry 316 is provided for receiving audio content via microphone 317 and for sending audio content to speaker 318.

The RF circuitry 314 includes well-known circuitry for performing various wireless communication functions, including an antenna system, an RF transceiver, one or more amplifiers, a tuner, one or more oscillators, a digital signal processor, a CODEC chipset, a subscriber identity module (SIM) card, memory, and so forth. The RF circuitry 314 communicates using standard communication protocols with various types of networks, such as the Internet, an intranet, a wireless network, such as a cellular telephone network, a wireless local area network (LAN), a metropolitan area network (MAN), and other compatible devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi), voice over Internet Protocol (VoIP), Wi-MAX, an email protocol (e.g., Internet message access protocol (IMAP) or post office protocol (POP)), instant messaging (e.g., extensible messaging and presence protocol (XMPP), Session Initiation Protocol for Instant Messaging and Presence Leveraging Extensions (SIMPLE), or Instant Messaging and Presence Service (IMPS) or Short Message Service (SMS)), or any other suitable communication protocol.

The audio circuitry 316 receives audio data from the peripherals interface 306, converts the audio data to an electrical signal, and transmits the electrical signal to speaker 318, where the electrical signal is converted to human-audible sound waves. The audio circuitry 316 also receives electrical signals converted by the microphone 317 from sound waves, converts the electrical signals to audio data, and transmits the audio data to the peripherals interface 306 for processing.

Audio data may be retrieved from and/or transmitted to memory 308 and/or the RF circuitry 314 by the peripherals interface 306. In some embodiments, the audio circuitry 316 also includes a headset jack (e.g., element 124 in FIG. 1). The headset jack provides an interface between the audio circuitry 316 and removable audio input/output peripherals, such as output-only headphones or a headset having both output means, such as a headphone for one or both ears, and input means, such as a microphone.

The I/O subsystem 320 couples peripheral devices to the peripheral interface 206. For example, a display controller module 322 provides communication and control for the touch screen display 106, while a camera controller module 324 provides communication and control for the optical sensor 134. Other input and/or output controllers (not shown) may be provided for other input or control devices, such as physical buttons (e.g., push buttons, rocker buttons, etc.), dials, slider switches, joysticks, click wheels, and so forth.

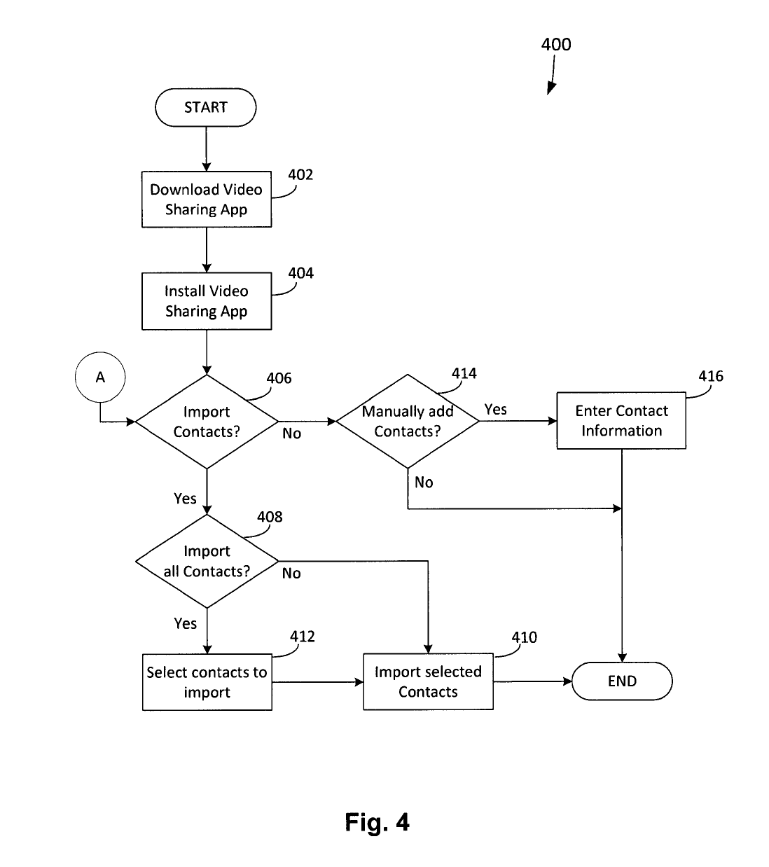

FIG. 4 illustrates a process 400 for installing the video sharing application on user device 200. In step 402, the video sharing application is downloaded into the device 200. For example, the video sharing application may be available for download from the App Store or a web site, or by direct file transfer from another device. In step 404, the video sharing application is installed on the device 200. In an embodiment, steps 402 and 404 are integrated as a single step. In step 406, the installed video sharing application asks if the user wants to import contacts from a contact application installed in the device 200. If so, then in step 408, the video sharing application asks if user wants to import all the contacts in device 200. If so, then the selected contacts are imported in step 410.

If the user does not want to import all contacts in step 408, then the video sharing application asks the user to identify specific contacts to import in step 412. The selected contacts are then imported in step 410.

If the user does not want to import any of the contacts from device 200 in step 406, then the video sharing application asks if the user wants to manually enter contact information in step 414. In step 416, the user enters the contact information into the video sharing application.

If the user does not want to add any contacts, then process 400 ends, but will be repeated the next time the user opens the video sharing program. At least one contact must be stored with the video sharing program in order for the user of device 200 to share video content.

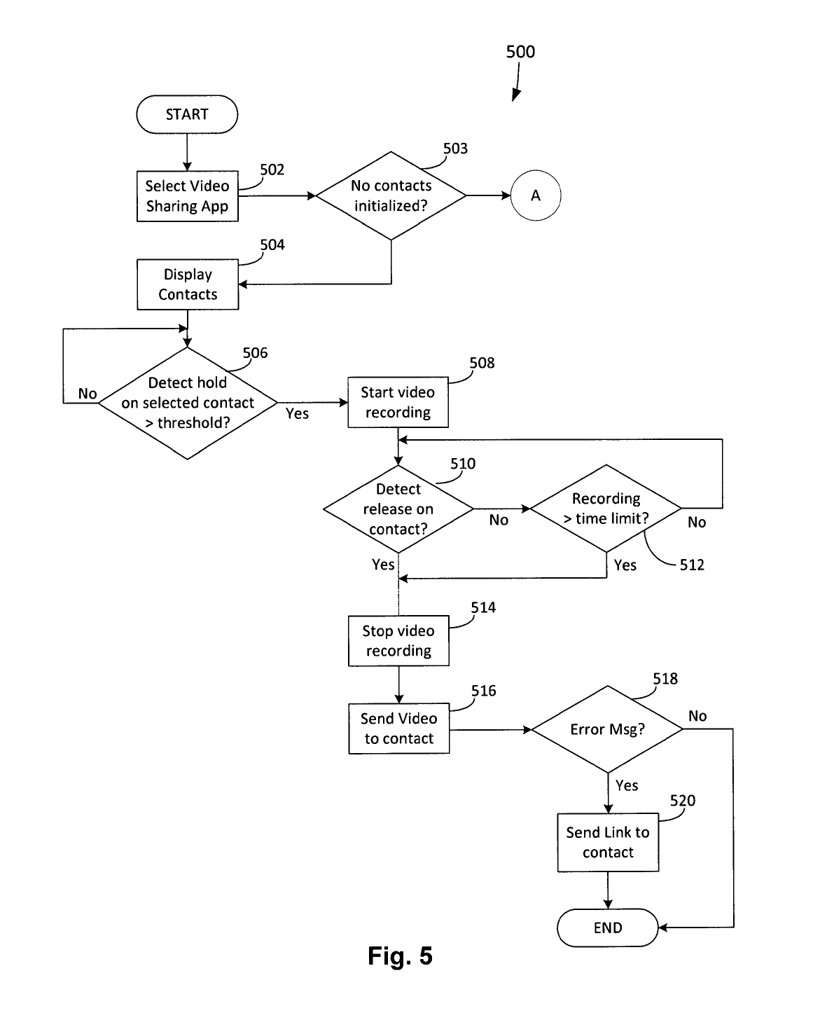

FIG. 5 illustrates a process 500 that enables a user to share video content with a person on the user's contact list that is associated with the video sharing application. In step 502, the video sharing application H OP is selected from the interface 104 by a user interaction, e.g., the user touches the icon for the video sharing application with a finger. In step 503, if no contacts have been stored or associated with the video sharing application, then process 500 returns to step 406 of process 400 to initialize at least one contact in the video sharing application before proceeding.

If contacts have been initialized, in step 504, the user's contacts that are associated with the video sharing application are displayed on the interface 104, for example, as a simple list of names, or as thumbnails, icons or any other know representations.

If a touch and hold action on a listed contact is detected for longer than a predefined threshold in step 506, then a video recording is started in step 508. For example, a predefined threshold for holding the contact, such as 2 seconds, may be set as a default value or can be changed in settings for the application.

If the contact is released in step 510, or a preset time limit expires in step 512, then the recording is stopped in step 514. As an example, the video recording may be limited to 30 seconds or any other preset time, e.g., through settings. If the contact has not been released in step 510, then the time limit is checked in step 512. If the preset time limit has expired, then the recording is stopped in step 514 regardless of whether the contact has been released on the touch screen 104. Once the recording is stopped in step 514, the video recording is then automatically and immediately transmitted to the user device associated with the contact that was selected and held in step 506 for longer than the threshold time.

If an error message is received back from the contact in step 518, then the selected contact does not have the video sharing application installed on their device, and a message is then sent to the contact in step 520 with a link that enables the contact to download the video sharing application. For example, the message might say that the sender wants to share a video and requests that you download the video sharing application.

Thus, using the video sharing application described above, a user can, with a single gesture, choose a recipient by selecting and holding a contact on the interface of the user's smartphone, which automatically starts a video recording, and upon releasing the contact, or after a preset recording time expires, automatically transmits the video recording to the recipient.

Although illustrative embodiments have been shown and described by way of example, a wide range of alternative embodiments is possible within the scope of the foregoing disclosure.

1. A method for sharing video content comprising:
displaying a plurality of contacts on a touch screen interface associated with a video sharing application installed on a first mobile device;
detecting that one of the plurality of contacts displayed on the touch screen interface of the first mobile device has been selected and is being held for a period of time that exceeds a predefined threshold;
recording video content using the first mobile device while the one contact on the touch screen interface of the first mobile device is being held; and
detecting that the one contact on the touch screen interface of the first mobile device is released, wherein release of the contact causes the recording to be terminated and automatically transmitted to a second mobile device associated with the selected contact.

2. The method of claim 1, further comprising:
starting a timer when the recording step begins; and
stopping the recording either when the timer exceeds a predefined time limit or when the one contact is released by the user.

3. The method of claim 1, further comprising the video sharing application retrieving the plurality of contacts from a contact application stored on the first mobile device.

4. The method of claim 1, further comprising the video sharing application automatically retrieving the plurality of contacts from a contact application stored on the first mobile device when the video sharing application is selected.

5. The method of claim 1, further comprising:
displaying a request on the interface for the first user to enter at least one contact; and
receiving information from the first user for at least one contact.

6. The method of claim 1, further comprising:
detecting whether the second mobile device has the video sharing application installed; and if not,
transmitting a message to the second mobile device including a link to download the video sharing application.

7. A computer program product comprising computer-readable program code to be executed by one or more processors when retrieved from a non-transitory computer-readable medium, the program code including instructions to:
display a plurality of contacts on a touch screen interface associated with a video sharing application installed on a first mobile device;
detect that one of the plurality of contacts displayed on the touch screen interface of the first mobile device has been selected and is being held for a period of time that exceeds a predefined threshold;
record video content using the first mobile device while the one contact on the touch screen interface of the first mobile device is being held; and
detect that the one contact on the touch screen interface of the first mobile device is released, wherein release of the contact causes the recording to be terminated and automatically transmitted to a second mobile device associated with the selected contact.

8. The computer program product of claim 7, the program code further including instructions to:
start a timer when the recording step begins; and
stop the recording either when the timer exceeds a predefined time limit or when the one contact is released by the user.

9. The computer program product of claim 1, the program code further including instructions to enable the video sharing application to retrieve the plurality of contacts from a contact application stored on the first mobile device.

10. The computer program product of claim 9, the program code further including instructions to:
display a request on the interface for the first user to enter at least one contact; and
receive information from the first user for at least one contact.

11. The computer program product of claim 10, the program code further including instructions to:
detect whether the second mobile device has the video sharing application installed; and if not,
transmit a message to the second mobile device including a link to download the video sharing application.

12. A system for sharing video content, the system comprising:
a processor-based application, which when executed on a computer, will cause the processor to:
display a plurality of contacts on a touch screen interface associated with a video sharing application installed on a first mobile device;
detect that one of the plurality of contacts displayed on the touch screen interface of the first mobile device has been selected and is being held for a period of time that exceeds a predefined threshold;
record video content using the first mobile device while the one contact on the touch screen interface of the first mobile device is being held; and
detect that the one contact on the touch screen interface of the first mobile device is released, wherein release of the contact causes the recording to be terminated and automatically transmitted to a second mobile device associated with the selected contact.

13. The system of claim 12, wherein the processor-based application, when executed, will further cause the processor to:
start a timer when the recording step begins; and
stop the recording either when the timer exceeds a predefined time limit or when the one contact is released by the user.

14. The system of claim 12, wherein the processor-based application, when executed, will further cause the processor to enable the video sharing application to retrieve the plurality of contacts from a contact application stored on the first mobile device.

15. The system of claim 14, wherein the processor-based application, when executed, will further cause the processor to:
display a request on the interface for the first user to enter at least one contact; and
receive information from the first user for at least one contact.

16. The system of claim 15, wherein the processor-based application, when executed, will further cause the processor to:
detect whether the second mobile device has the video sharing application installed; and if not,
transmit a message to the second mobile device including a link to download the video sharing application.
